(19) United States
(12) Patent Application Publication
(10) Pub. No.: US 2025/0024505 A1
(43) Pub. Date: Jan. 16, 2025

(54) SIDELINK UNLICENSED RESOURCE RESERVATION

(71) Applicant: Huawei Technologies Co., Ltd., Shenzhen (CN)

(72) Inventors: George Calcev, Hoffman Estates, IL (US); Weimin Xiao, Hoffman Estates, IL (US); Brian Classon, St. Pete Beach, FL (US); Guosen Yue, Edison, NJ (US)

(21) Appl. No.: 18/903,776

(22) Filed: Oct. 1, 2024

Related U.S. Application Data
(63) Continuation of application No. PCT/US2023/020196, filed on Apr. 27, 2023.
(60) Provisional application No. 63/336,083, filed on Apr. 28, 2022.

(51) Int. Cl. H04W 74/0816; H04W 72/25

(52) U.S. Cl. CPC H04W 74/0816; H04W 72/25

(57) ABSTRACT

According to embodiments, a user equipment (UE) performs a first type of sensing in a sensing window to detect first one or more SL transmissions using a sidelink (SL) radio access technology (RAT). The UE performs a second type of sensing to detect second one or more transmissions using a non-SL RAT different from the SL RAT. The second type is different from the first type. The UE selects an SL resource in an unlicensed band in a selection window for an SL transmission based on the first type of sensing and the second type of sensing. The UE transmits the SL transmission via the SL resource using the SL RAT.

### CROSS-REFERENCE TO RELATED APPLICATIONS

This application is a continuation of International Patent Application No. PCT/US2023/020196 filed on Apr. 27, 2023 and entitled “Sidelink Unlicensed Resource Reservation,” which claims priority to U.S. Provisional Patent Application No. 63/336,083, filed on Apr. 28, 2022 and entitled “Sidelink Unlicensed Resource Reservation,” applications of which are incorporated herein by reference in their entireties.

### TECHNICAL FIELD

The present disclosure relates generally to methods and apparatus for wireless communications, and, in particular embodiments, to methods and apparatus for sidelink (SL) unlicensed resource reservation.

### BACKGROUND

Support for vehicle to vehicle (V2V) and vehicle to everything (V2X) services has been introduced in LTE during Releases 14 and 15 to expand the 3GPP platform to the automotive industry (TR 36.885, TR 38.885). The work items (RP-152293, RP-172293) defined the LTE sidelink (SL) suitable for vehicular applications, and complementary enhancements to the cellular infrastructure. Examples of V2X use case scenarios include the following.
Vehicles Platooning enables vehicles to dynamically form a platoon travelling together.
Extended Sensors enable the exchange of raw or processed data gathered through local sensors or live video images among vehicles, road site units (RSU), devices of pedestrian, and V2X application servers.
Advanced Driving enables semi-automated or full-automated driving.
Remote Driving enables a remote driver or a V2X application to operate a remote vehicle for those passengers who cannot drive by themselves, or remote vehicles located in dangerous environments.

### SUMMARY

Technical advantages are generally achieved, by embodiments of this disclosure which describe methods and apparatus for sidelink (SL) unlicensed resource reservation.

According to embodiments, a user equipment (UE) performs a first type of sensing in a sensing window to detect first one or more SL transmissions in an unlicensed band using a SL radio access technology (RAT). The UE performs a second type of sensing to detect second one or more transmissions in the unlicensed band using a non-SL RAT different from the SL RAT. The second type is different from the first type. The UE selects an SL resource in the unlicensed band in a selection window for an SL transmission based on the first type of sensing and the second type of sensing. The UE transmits the SL transmission via the SL resource using the SL RAT.

In some embodiments, the non-SL RAT may comprise a wireless fidelity (WiFi) RAT.

In some embodiments, to perform the first type of sensing, the UE may receive a sidelink control information (SCI), decode the SCI, and measure a reference signal received power (RSRP) based on the SCI to determine first one or more occupied resources in the unlicensed band. In some embodiments, the UE may exclude the first one or more occupied resources from the set of resources used for candidate selection.

In some embodiments, to perform the second type of sensing, the UE may detect a decoding failure during the performing the first type of sensing, perform a clear channel assessment (CCA) procedure, and measure a received signal strength indicator (RSSI) during the CCA procedure to identify second one or more occupied resources in the unlicensed band sensed by the CCA procedure. In some embodiments, the UE may exclude the second one or more occupied resources from the set of resources used for candidate selection based on the decoding failure and the RSSI. In some embodiments, the UE may exclude the second one or more occupied resources from the set of resources used for candidate selection based on the decoding failure and the RSSI below a threshold. In some embodiments, to measure the RSSI, the UE may measure the RSSI in at least one symbol in an SL slot or in a fraction of time of each of the at least one symbol in the SL slot.

In some embodiments, the selection window may be no earlier than a listen before talk (LBT) duration of a LBT procedure.

In some embodiments, the UE may determine possible future resources that may be occupied based on the first type of sensing and the second type of sensing. The UE may exclude the possible future resources from the set of resources used for candidate selection.

In some embodiments, the UE may determine a channel access busy ratio (CABR) corresponding to a portion of SL sub-channels occupied by the first one or more SL transmissions only or by the second one or more transmissions only in a SL resource pool. The UE may perform SL congestion control based on the CABR.

In some embodiments, the UE may determine a channel busy ratio (CBR) corresponding to a portion of SL sub-channels occupied by the first one or more SL transmissions only or by the second one or more transmissions only in a SL resource pool. The UE may perform SL congestion control based on the CBR.

In some embodiments, the UE may collect statistics of an availability of one or more resources occupied by a RAT transmission in the unlicensed band. A result of the statistics is used for selecting at least one of a preferred resource or non-preferred resource to be used in an Inter UE Coordination (IUC) process. In some embodiments, the UE may collect an RSRP for one or more symbols of the sensing window. The UE may decode an SCI. Collecting the statistic of the availability of the one or more resources may be performed when the UE fails to decode the SCI and the RSSI is larger than a threshold.

### BRIEF DESCRIPTION OF THE DRAWINGS

For a more complete understanding of the present disclosure, and the advantages thereof, reference is now made to the following descriptions taken in conjunction with the accompanying drawings, in which:

FIG. 1A illustrates an example communications system 100, according to embodiments;

FIG. 1B shows examples of SL UEs in coverage, partial coverage, and out of coverage (OOC), according to some embodiments;

FIG. 2 shows basic sensing and resource selection timing, according to some embodiments;

FIG. 3 shows an example of inferring a non-SL RAT transmission, according to some embodiments;

FIG. 4 illustrates an example of slot based SL transmissions, according to some embodiments;

FIG. 5 shows an example of the measuring window for Channel Access Busy Ratio (CABR);

FIG. 6A shows a flow chart for the resource reservation of an SL UE, according to some embodiments;

FIG. 6B shows a flow chart of a method performed by a UE for SL resource reservation, according to some embodiments;

FIG. 7 illustrates an example communication system, according to some embodiments;

FIGS. 8A and 8B illustrate example embodiment devices that may implement the methods and teachings according to this disclosure; and

FIG. 9 is a block diagram of a computing system that may be used for implementing the devices and methods disclosed herein, according to some embodiments.

Corresponding numerals and symbols in the different figures generally refer to corresponding parts unless otherwise indicated. The figures are drawn to clearly illustrate the relevant aspects of the embodiments and are not necessarily drawn to scale.

### DETAILED DESCRIPTION OF ILLUSTRATIVE EMBODIMENTS

The making and using of embodiments of this disclosure are discussed in detail below. It should be appreciated, however, that the concepts disclosed herein can be embodied in a wide variety of specific contexts, and that the specific embodiments discussed herein are merely illustrative and do not serve to limit the scope of the claims. Further, it should be understood that various changes, substitutions and alterations can be made herein without departing from the spirit and scope of this disclosure as defined by the appended claims.

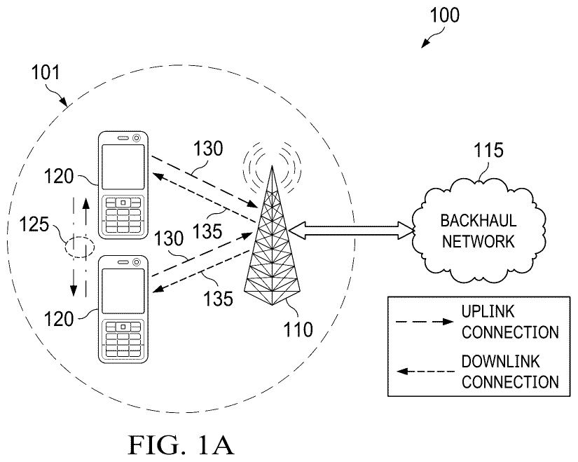

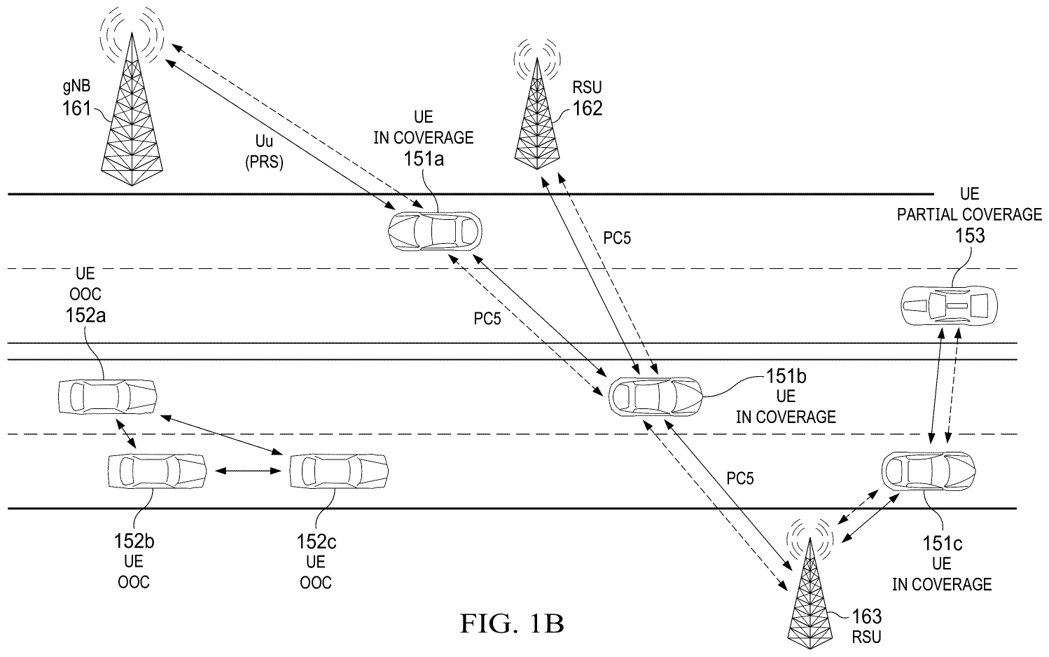

FIG. 1A illustrates an example communications system 100, according to embodiments. Communications system 100 includes an access node 110 serving user equipments (UEs) with coverage 101, such as UEs 120. In a first operating mode, communications to and from a UE passes through access node 110 with a coverage area 101. The access node 110 is connected to a backhaul network 115 for connecting to the internet, operations and management, and so forth. In a second operating mode, communications to and from a UE do not pass through access node 110, however, access node 110 typically allocates resources used by the UE to communicate when specific conditions are met. Communications between a pair of UEs 120 can use a sidelink connection (shown as two separate one-way connections 125). In FIG. 1A, the sideline communication is occurring between two UEs operating inside of coverage area 101. However, sidelink communications, in general, can occur when UEs 120 are both outside coverage area 101, both inside coverage area 101, or one inside and the other outside coverage area 101. Communication between a UE and access node pair occur over uni-directional communication links, where the communication links between the UE and the access node are referred to as uplinks 130, and the communication links between the access node and UE is referred to as downlinks 135.

Access nodes may also be commonly referred to as Node Bs, evolved Node Bs (eNBs), next generation (NG) Node Bs (gNBs), master eNBs (MeNBs), secondary eNBs (SeNBs), master gNBs (MgNBs), secondary gNBs (SgNBs), network controllers, control nodes, base stations, access points, transmission points (TPs), transmission-reception points (TRPs), cells, carriers, macro cells, femtocells, pico cells, and so on, while UEs may also be commonly referred to as mobile stations, mobiles, terminals, users, subscribers, stations, and the like. Access nodes may provide wireless access in accordance with one or more wireless communication protocols, e.g., the Third Generation Partnership Project (3GPP) long term evolution (LTE), LTE advanced (LTE-A), 5G, 5G LTE, 5G NR, sixth generation (6G), High Speed Packet Access (HSPA), the IEEE 802.11 family of standards, such as 802.11a/b/g/n/ac/ad/ax/ay/be, etc. While it is understood that communications systems may employ multiple access nodes capable of communicating with a number of UEs, only one access node and two UEs are illustrated for simplicity.

In Technical Specification Group (TSG) radio access network (RAN), a set of corresponding 5G RAN requirements, channel models, etc., for new radio (NR) have been defined in TR 37.885 and TR 38.913.

Although NR sidelink was initially developed for V2X applications, there is growing interest in the industry to expand the applicability of NR sidelink to commercial use cases. For commercial sidelink applications, two requirements have been identified:
(1) increased sidelink data rates, and
(2) support of new carrier frequencies for sidelink.

Increased sidelink data rate is motivated by applications such as sensor information (e.g., video) sharing between vehicles with a high degree of driving automation. Commercial use cases could require data rates more than what is possible in Rel-17. Increased data rates can be achieved with the support of sidelink carrier aggregation and sidelink over unlicensed spectrum. Furthermore, by enhancing frequency range 2 (FR2) sidelink operation, increased data rates can be more efficiently supported on FR2. While the support of new carrier frequencies and larger bandwidths would also allow improvements to the data rate on the sidelink, the main benefit would come from making sidelink more applicable for a wider range of applications. More specifically, with the support of unlicensed spectrum and enhancements in FR2, the sidelink can likely be implemented in commercial devices since utilization of the intelligent transport systems (ITS) band is limited to ITS safety related applications.

There are two 3GPP defined resource allocation modes for sidelink resource allocation: Mode 1 and Mode2 (TR 38.885).

In Mode 1, the base station schedules SL resource(s) to be used by the UE for SL transmission(s). In Mode 1 (NR Uu link), the base station can assign NR SL resources for the cases of (i) a licensed carrier shared between NR Uu and NR SL (PC5 link); and (ii) a carrier dedicated to NR SL. Mode 1 may be used in coverage but cannot be used out-of-coverage. The following techniques are supported for resource allocation Mode 1 (in coverage):
dynamic resource allocation, and
configured grant Type 1 and Type 2.

In Mode 2, the UE determines (i.e., the base station does not schedule) SL transmission resource(s) within SL resources configured by the base station/network or pre-configured SL resources. Mode 2 may be used in coverage or out-of-coverage (OOC).

The definition of SL resource allocation Mode 2 covers the following:
a) the UE autonomously selects SL resource for transmission;
b) the UE assists SL resource selection for other UE(s), a functionality which can be part of a), c), d);
c) the UE is configured with NR configured grant (Type-1 like) for SL transmission; and
d) the UE schedules SL transmissions of other UEs.

Sensing-and resource (re-)selection-related procedures are supported for resource allocation Mode 2.

FIG. 1B shows examples of SL UEs in coverage, partial coverage, and out of coverage (OOC), according to some embodiments. The UE 151a is in the coverage of the gNB 161. The UE 151a and the gNB 161 can communicate with each other using the Uu interface. The UE 151b is in the coverage of the road side unit (RSU) 162 and the RSU 163 and can use the PC5 interface to communicate with the RSU 162 and/or the RUS 163. The UE 151c is in the coverage of the RSU 163.

The UEs 152a, 152b, and 152c are OOC SL UEs. Further, The UE 153 is in the partial coverage. The UEs can communicate with one another using the PC5 interface (e.g., between the UE 151a and the UE 151b).

Each transport block (TB) has an associated sidelink control information (SCI) message. The SCI is split in two stages: the 1^{st}-stage SCI that is carried in the Physical Sidelink Control Channel (PSCCH), and the 2^{nd}-stage SCI that is carried in Physical Sidelink Shared Channel (PSSCH).

A PSCCH may carry SCI. A source UE uses the SCI to schedule transmission of data on a PSSCH or reserve a resource for the transmission of the data on the PSSCH. The SCI may convey the time and frequency resources of the PSSCH, and/or parameters for hybrid automatic repeat request (HARQ) process, such as a redundancy version, a process id (or ID), a new data indicator, and/or resources for the Physical Sidelink Feedback Channel (PSFCH). The time and frequency resources of the PSSCH may be referred to as resource assignment or allocation and may be indicated in the time resource assignment field and/or a frequency resource assignment field (i.e., resource locations). The PSFCH carries HARQ feedback over the sidelink from a UE which is an intended recipient of a PSSCH transmission to the UE which performed the transmission.

HARQ feedback is called HARQ-ACK. The HARQ-ACK carries ack or nack indicating whether a destination UE decoded or not the payload carried on the PSSCH correctly. The SCI may also carry a bit field indicating or identifying the source UE. In addition, the SCI may carry a bit field indicating or identifying the destination UE. The SCI may further include other fields to carry information such as a modulation coding scheme used to encode the payload and modulate the coded payload bits, a demodulation reference signal (DMRS) pattern, antenna ports, a priority of the payload (transmission), and so on. A sensing UE performs sensing on a sidelink (i.e., receiving a PSCCH sent by another UE), and decoding SCI carried in the PSCCH to obtain information of resources reserved by another UE, and determining resources for sidelink transmissions of the sensing UE.

The sensing procedure is defined as decoding SCI(s) from other UEs and/or SL measurements. Decoding SCI(s) in this procedure provides at least information on SL resources indicated by the UE transmitting the SCI. The sensing procedure uses a L1 SL RSRP measurement based on SL DMRS when the corresponding SCI is decoded. The resource (re-)selection procedure considered uses the results of the sensing procedure to determine resource(s) for SL transmission.

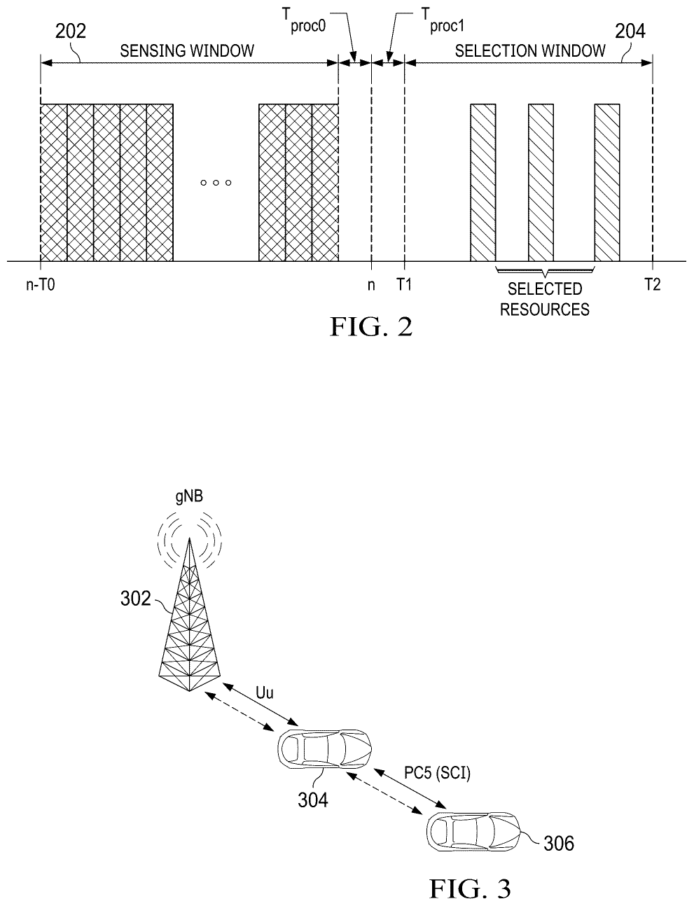

The basic sensing and resource selection timing is illustrated in FIG. 2, according to some embodiments. T_{proc,0} is the time required for a UE to complete the sensing process, and T_{proc,1} is the maximum time required for a UE to identify candidate resources and select new sidelink resources.

During the sensing window 202, an SL UE decodes the SCI(s) from other UEs and performs SL measurements. Among the information provided by the 1^{st} stage of SCI format carried in PSSCH (SCI Format 1-A) (TS 38.212), there are:
Priority—3 bits as specified in clause 5.4.3.3 of (12, TS 23.287) and clause 5.22.1.3.1 of (8, TS 38.321). Value ‘000’ of the Priority field corresponds to priority value ‘1’, value ‘001’ of the Priority field corresponds to priority value ‘2’, and so on. A lower priority value corresponds to a higher priority, and a higher priority value corresponds to a lower priority.
Frequency resource assignment
Time resource assignment
Resource reservation period
DMRS pattern
2^{nd} stage SCI format, and/or
Number of DMRS ports, Modulation Coding Scheme (MCS).

For SL PC5, the priority level value is provided by the upper layers. A quality of service (QOS) model like that defined in TS 23.501 for Uu reference point is used, and it is based on PC5 QoS Indicator (PQI) values. Table 1 is a correspondence between the priority levels and PQI values.

TABLE 1
(Standardized PQI to QoS characteristics mapping)

| | | | | | Default | | |
|---|---|---|---|---|---|---|---|
| | | | | | Max. | | |
| | | Default | Packet | Packet | Data | Default | |
| PQI | Resource | Priority | Delay | Error | Burst | Averaging | Example |
| Value | Type | Level | Budget | Rate | Volume | Window | Services |
| 21 | GBR | 3 | 20 ms | 10⁻⁴ | N/A | 2000 ms | Platooning |
| | (NOTE 1) | | | | | | between UEs - |
| | | | | | | | Higher |
| | | | | | | | degree of |
| | | | | | | | automation; |
| | | | | | | | Platooning |
| | | | | | | | between UE |
| | | | | | | | and RSU - |
| | | | | | | | Higher |
| | | | | | | | degree of |
| | | | | | | | automation |
| 22 | | 4 | 50 ms | 10⁻² | N/A | 2000 ms | Sensor |
| | | | | | | | sharing - |
| | | | | | | | higher |
| | | | | | | | degree of |
| | | | | | | | automation |
| 23 | | 3 | 100 ms | 10⁻⁴ | N/A | 2000 ms | Information |
| | | | | | | | sharing for |
| | | | | | | | automated |
| | | | | | | | driving - |
| | | | | | | | between UEs |
| | | | | | | | or UE |
| | | | | | | | and RSU - |
| | | | | | | | higher |
| | | | | | | | degree of |
| | | | | | | | automation |
| 55 | Non- | 3 | 10 ms | 10⁻⁴ | N/A | N/A | Cooperative |
| | GBR | | | | | | lane change - |
| | | | | | | | higher |
| | | | | | | | degree of |
| | | | | | | | automation |
| 56 | | 6 | 20 ms | 10⁻¹ | N/A | N/A | Platooning |
| | | | | | | | informative |
| | | | | | | | exchange - |
| | | | | | | | low degree of |
| | | | | | | | automation; |
| | | | | | | | Platooning - |
| | | | | | | | information |
| | | | | | | | sharing |
| | | | | | | | with RSU |
| 57 | | 5 | 25 ms | 10⁻¹ | N/A | N/A | Cooperative |
| | | | | | | | lane change - |
| | | | | | | | lower degree |
| | | | | | | | of automation |
| 58 | | 4 | 100 ms | 10⁻² | N/A | N/A | Sensor |
| | | | | | | | information |
| | | | | | | | sharing - |
| | | | | | | | lower degree |
| | | | | | | | of automation |
| 59 | | 6 | 500 ms | 10⁻¹ | N/A | N/A | Platooning - |
| | | | | | | | reporting to |
| | | | | | | | an RSU |
| 90 | Delay | 3 | 10 ms | 10⁻⁴ | 2000 | 2000 ms | Cooperative |
| | Critical | | | | bytes | | collision |
| | GBR | | | | | | avoidance; |
| | (NOTE 1) | | | | | | Sensor |
| | | | | | | | sharing - |
| | | | | | | | Higher |
| | | | | | | | degree of |
| | | | | | | | automation; |
| | | | | | | | Video sharing - |
| | | | | | | | higher degree |
| | | | | | | | of automation |
| 91 | | 2 | 3 ms | 10⁻⁵ | 2000 | 2000 ms | Emergency |
| | | | | | bytes | | trajectory |
| | | | | | | | alignment; |
| | | | | | | | Sensor sharing - |
| | | | | | | | Higher degree |
| | | | | | | | of automation |

(NOTE 1):
GBR and Delay Critical GBR PQIs can only be used for unicast PC5 communications.
(NOTE 1):
For Standardized PQI to QoS characteristics mapping, the table will be extended/updated to support service requirements for other identified V2X services.
NOTE 2:
The PQIs may be used for other services than V2X.
NOTE 3:
A PQI may be used together with an application indicated priority, which overrides the Default Priority Level of the PQI.

The Priority Level is used to select for which PC5 service data the QoS requirements are prioritized such that a PC5 service data packet with Priority Level value N is prioritized over a PC5 service data packet having higher Priority Level values (i.e., N+1, N+2, etc.), with the lower number meaning higher priority.

The PC5 priority level (also known as SL reservation priority, data priority (where data priority defines reservation priority), or SL priority) provided in the SCI is used for determining the subset of resources to be reported to higher layers in PSSCH resource selection in sidelink resource allocation mode 2 (TS 38.214).

To trigger this procedure, in slot n, the higher layer provides the following parameters for this PSSCH/PSCCH transmission:
the resource pool from which the resources are to be reported;
L1 priority, prio_{TX};
the remaining packet delay budget;
the number of sub-channels to be used for the PSSCH/PSCCH transmission in a slot, L_{subCH};
optionally, the resource reservation interval, P_{rsvp_TX}, in units of msec.
If the higher layer requests the UE to determine a subset of resources from which the higher layer will select resources for PSSCH/PSCCH transmission as part of re-evaluation or pre-emption procedure, the higher layer provides a set of resources (r₀, r₁, r₂, . . . ) which may be subject to re-evaluation and a set of resources (r₀′, r₁′, r₂′, . . . ) which may be subject to pre-emption.
It is up to UE implementation to determine the subset of resources as requested by higher layers before or after the slot rᵢ″−T₃, where rᵢ″ is the slot with the smallest slot index among (r₀, r₁, r₂, . . . ) and (r₀′, r₁′, r₂′, . . . ), and T₃ is equal to T_{proc,1}^{SL}, where T_{proc,1}^{SL} is defined in slots in Table 2 where μ_{SL} is the subcarrier spacing (SCS) configuration of the SL BWP.

TABLE 2
T_{proc, 1}^{SL} depending on sub-carrier spacing

| μ_{SL} | T_{proc, 1}^{SL} [slots] |
|---|---|
| 0 | 3 |
| 1 | 5 |
| 2 | 9 |
| 3 | 17 |

Optionally, the indication of resource selection mechanism(s), as allowedResourceSelectionConfig, which may comprise of full sensing only, partial sensing only, random resource selection only, or any combination(s) thereof.

During the sensing procedure, a monitoring UE detects SCI transmitted in each SL slot in the sensing window 202 and measures reference signal received power (RSRP) of the resource indicated in the SCI. A monitoring UE may also receive transmissions of data (also be a receiving UE) while sensing. For periodic traffic, the resource reservations for sidelink transmissions, if a UE occupies a resource on slot sₖ, it will also occupy the resource on slot sₖ+q*RRIₘ where q is an integer, RRIₘ is resource reservation interval for UEₘ that the sensing UE detected. Detecting includes the steps of receiving and decoding the PSCCH and processing the SCI within the PSCCH.

For aperiodic or dynamic transmissions, the transmitting UE reserves multiple resources and indicates the next resource in the SCI. Therefore, based on the sensing results, a monitoring UE can determine which resources may be occupied in the future and can avoid them for its own transmission if the measured RSRP on the occupied resource is larger than a RSRP threshold during the sensing period.

When resource selection is triggered on slot n in FIG. 2, based on sensing results in the sensing window 202 (i.e., on slots [n−T₀, n−T_{proc,0}]), the transmitting UE selects the resources in the resource selection window 204 (i.e., on slots [n+T₁, n+T₂]), where
T₀: number of slots with the value determined by resource pool configuration;
T_{proc,0}: time required for a UE to complete the sensing process;
T₁: processing time required for identification of candidate resources and resource selection T₁≤T_{proc,1};
T₂: the last slot of resource pool for resource selection which is left to UE implementation but in the range of [T_{2min,} PDB] where T₂ₘᵢₙ is minimum value of T₂ and PDB denotes packet delay budget, the remaining time for UE transmitting the data packet;
T_{proc,1}: maximum time required for a UE to identify candidate resources and select new sidelink resources.

To select a resource, the transmitting UE needs to identify the candidate resources by excluding the occupied resources with measured RSRP over a configured RSRP threshold. Then, the transmitting UE compares the ratio of the available resources over all resources in the selection window 204.

If the available resource ratio is greater than a threshold X%, then UE selects a resource randomly among the candidate resources.

The SL priority level is used to decide upon the available resource ratio as follows. If the ratio is smaller, the transmitting UE then increases the RSRP threshold by 3 dB and checks the available resource ratio until the available resource ratio is equal to or greater than X%, where X is chosen from a list, sl-TxPercentageList, and its value is determined by data priority (SL priority level), as specified in TS38.214:

sl-TxPercentageList: internal parameter X for a given prio_{TX} is defined as sl-TxPercentageList (prio_{TX}) converted from percentage to a ratio.

The possible values of X in sl-TxPercentageList are 20, 35, and 50 (which correspond to 20%, 35%, and 50%, respectively), as specified in TS38.331 below:

| | |
|---|---|
| SL-TxPercentageList-r16 ::= | SEQUENCE (SIZE (8)) OF SL-TxPercentageConfig-r16 |
| SL-TxPercentageConfig-r16 ::= | SEQUENCE { |
| sl-Priority-r16 | INTEGER (1..8), |
| sl-TxPercentage-r16 | ENUMERATED {p20, p35, p50} |
| } | |

The SL resource selection takes place in two steps. In the first step, the sidelink specification in shared spectrum (SL-U) UE monitors the sensing window 202 and based on the decoded SCI and measured RSRP constructs the candidate resource list from the resource candidates in the selection window 204, as described above. The candidate resource list is then provided to the upper layer. In the second step, the upper layer selects from the candidate resource list the list of selected resources, which is provided to the PHY layer.

It is worth mentioning that in the selection window 204 definition in FIG. 2, selection of T₁ is up to UE implementation under 0≤T₁≤T_{proc,1}^{SL}.

The set S_{A}, used for candidate selection, is initialized to the set of all the candidate single-slot resources.

The UE shall exclude any candidate single-slot resource R_{x,y} from the set S_{A} if it meets all the following conditions:
the UE has not monitored slot t′m^{SL};
for any periodicity value allowed by the higher layer parameter sl-ResourceReservePeriodList and a hypothetical SCI format 1-A received in slot t′ₘ^{SL} with ‘Resource reservation period’ field set to that periodicity value and indicating all subchannels of the resource pool in this slot, it overlaps with an existing reservation in the selection window 204.

Congestion control in SL is used to limit the access and avoid the possible collisions. For this purpose, two measures are defined in TS 38.215.
Channel Busy Ratio (CBR): measured in slot n is defined as the portion of sub-channels in the resource pool whose SL RSSI measured by the UE exceed a (pre-)configured threshold sensed over a CBR measurement window [n−a, n−1],
Channel Occupancy Ratio (CR): evaluated at slot n is defined as the total number of sub-channels used for its transmissions in slots [n−a, n−1] and granted in slots [n, n+b] divided by the total number of configured sub-channels in the transmission pool over [n−a, n+b].

The higher layer via IE SL-CBR-PriorityTxConfigList indicates the mapping between PSSCH transmission parameter (such as MCS, PRB number, retransmission number, CR limit) sets by using the indexes of the configurations provided in sl-CBR-PSSCH-TxConfigList, CBR ranges by an index to the entry of the CBR range configuration in sl-CBR-RangeConfigList, and priority ranges.

Thus, the CR and CBR are used to:
select the number of HARQ retransmissions from the allowed numbers, if configured by RRC, in sl-MaxTxTransNumPSSCH included in sl-PSSCH-TxConfigList and, if configured by RRC, overlapped in sl-MaxTxTransNumPSSCH indicated in sl-CBR-PriorityTxConfigList for the highest priority of the logical channel(s) allowed on the carrier and the CBR measured by lower layers,
select an amount of frequency resources within the range, if configured by RRC, between sl-MinSubChannelNumPSSCH and sl-MaxSubchannelNumPSSCH included in sl-PSSCH-TxConfigList and, if configured by RRC, overlapped between MinSubChannelNumPSSCH and MaxSubchannelNumPSSCH indicated in sl-CBR-PriorityTxConfigList for the highest priority of the logical channel(s) allowed on the carrier and the CBR measured by lower layers,
select a MCS which is, if configured, within the range, if configured by RRC, between sl-MinMCS-PSSCH and sl-MaxMCS-PSSCH associated with the selected MCS table included in sl-PSSCH-TxConfigList and, if configured by RRC, overlapped between sl-MinMCS-PSSCH and sl-MaxMCS-PSSCH associated with the selected MCS table indicated in sl-CBR-PriorityTxConfigList for the highest priority of the sidelink logical channel(s) in the MAC PDU and the CBR measured by lower layers.

Congestion Control is defined for each transmission pool as:
Step 1: Configuration parameters are in place. NOTE: Parameters can be pre-configured or received via a network.
Step 2: Receive upper layer packet with its associated Prose Per Packet Priority (PPPP).
Step 3: Determine the PDB for this packet for this PPPP value, from configuration.
Step 4: Compute the current CBR.
Step 5: Compute CRlimit for this PPPP based on the CBR.
Step 6: Select transmit resources for the packet such that can meet the CR limit.

Where CR limit values corresponding to CBR measured range are defined Table 3 as follows.

TABLE 3

| CBR-based PSSCH | | | |
|---|---|---|---|
| transmission parameter | PPPP1- | PPPP3- | PPPP6- |
| configuration | PPPP2 | PPPP5 | PPPP8 |
| CBR measured | CR limit | CR limit | CR limit |
| 0 ≤ CBR measured ≤ 0.3 | No limit | No limit | No limit |
| 0.3 < CBR measured ≤ | No limit | 0.03 | 0.02 |
| 0.65 | | | |
| 0.65 < CBR measured ≤ | 0.02 | 0.006 | 0.004 |
| 0.8 | | | |
| 0.8 < CBR measured ≤ 1 | 0.02 | 0.003 | 0.002 |

Inter-UE coordination (IUC) is a part of SL design to deal with hidden node problem and half-duplex constraints. For IUC, three categories of resources are identified.
Preferred Resource(s) excludes those resource(s) overlapping with reserved resource(s) indicated by a received SCI format 1-A whose RSRP measurement is higher than an RSRP threshold (i.e., resources including those reserved by a received SCI whose RSRP is lower than RSRP threshold).
Non-preferred Resources include:
   resources due to half-duplex UE is supposed to receive on those resources or
   resources indicated by a SCI format 1-A that satisfies at least one of the following:
      the RSRP measurement performed, for the received (SCI format 1-A), is higher than some threshold Th(prio_RX) where prio_RX is the value of the priority field in the received (SCI format 1-A); or
      the UE is a destination UE of a TB associated with the received (SCI format 1-A) and the RSRP measurement performed for the received (SCI format 1-A), is lower than Th′(prio_RX) where prio_RX is the value of the priority field in the received (SCI format 1-A).
Note 1: The sets of preferred and non-preferred resource(s) are different for the transmitter and receiver, as they reflect a local view.
Note 2: The assumption is that the transmit reservation of UE-A are already known by UE-B and excluded from the selection window
Conflicted Resources:
   Reservations overlap via a second strong SCI>Th(prio₂, prio₁), here prio₂, prio₁ are in the received SCIs;
   UE is destination of two reservations |RSRP1-RSRP2|>(pre-)configured threshold;
Reservations that overlap with half-duplex situations.

### NR Channel Access in Shared Spectrum

Licensed exempt spectrum, also known as unlicensed spectrum, attracted a lot of interest from cellular operators. LTE-LAA (licensed assisted access) was specified in 3GPP LTE releases 13 and 14. More recently in new radio unlicensed (NR-U), the operation in unlicensed spectrum (shared spectrum) was specified in release 16 (TS 38.213).

3GPP and IEEE technologies operating in unlicensed spectrum use Listen Before Talk (LBT) channel access. In certain regions such European Union and Japan, the LBT rule is enforced by the spectrum regulators to reduce the interference risk and to offer a fair coexistence mechanism. The LBT mechanism requires the transmitter to check before a transmission to see if there are other occupants of the channel and postpone the transmission if the channel is occupied.

In particular, the LBT rule in EU specified in ETSI EN 301.893 for 5 GHz band uses Clear Channel Assessment (CCA) to determine if the channel is available for transmission. CCA checks if the energy received is above a threshold. If the energy detected exceeds the CCA threshold, the channel is considered in use (busy), otherwise is considered idle. If the channel is idle, the transmitter can transmit for a duration of channel occupancy time (COT) at a bandwidth at least e.g. 80% of the total channel bandwidth. The maximum COT (MCOT) duration for a transmission burst is also specified in ETSI EN 301893. The maximum COT duration adopted in 3GPP NR-U Rel 16 (TS 37.213) is a function of channel access priority class (CAPC). As defined in TS 37.213, for determining a Channel Occupancy Time (COT), if a transmission gap is less than or equal to 25 us, the gap duration is counted in the channel occupancy time. A transmission burst is defined as a set of transmissions with gaps no more than 16 us; if the gaps are larger than 16 us, the transmissions are considered separate.

3GPP (TS 37.213) defines several types of channel access for downlink (DL) and respectively uplink (UL).

### Type 1 UL Channel Access Procedure

This clause describes channel access procedures by a UE where the time duration spanned by the sensing slots that are sensed to be idle before a UL transmission(s) is random. The clause is applicable to the following transmissions:
PUSCH/SRS transmission(s) scheduled or configured by eNB/gNB, or
PUCCH transmission(s) scheduled or configured by gNB, or
Transmission(s) related to random access procedure.

A UE may transmit the transmission using Type 1 channel access procedure after first sensing the channel to be idle during the slot durations of a defer duration T_{d}, and after the counter N is zero in step 4. The counter N is adjusted by sensing the channel for additional slot duration(s) according to the steps described below.
1) set N=Nᵢₙᵢₜ, where Nᵢₙᵢₜ is a random number uniformly distributed between o and CWₚ, and go to step 4;
2) if N>0 and the UE chooses to decrement the counter, set N=N−1;
3) sense the channel for an additional slot duration, and if the additional slot duration is idle, go to step 4; else, go to step 5;
4) if N=0, stop; else, go to step 2;
5) sense the channel until either a busy slot is detected within an additional defer duration T_{d} or all the slots of the additional defer duration T_{d} are detected to be idle;
6) if the channel is sensed to be idle during all the slot durations of the additional defer duration T_{d}, go to step 4; else, go to step 5.

If a UE has not transmitted a UL transmission on a channel on which UL transmission(s) are performed after step 4 in the procedure above, the UE may transmit a transmission on the channel, if the channel is sensed to be idle at least in a sensing slot duration Tₛₗ when the UE is ready to transmit the transmission and if the channel has been sensed to be idle during all the slot durations of a defer duration T_{d} immediately before the transmission. If the channel has not been sensed to be idle in a sensing slot duration Tₛₗ when the UE first senses the channel after it is ready to transmit, or if the channel has not been sensed to be idle during any of the sensing slot durations of a defer duration T_{d} immediately before the intended transmission, the UE proceeds to step 1 after sensing the channel to be idle during the slot durations of a defer duration T_{d}.

The defer duration T_{d} consists of duration T_{f}=16 us immediately followed by mₚ consecutive slot durations where each slot duration is Tₛₗ=9 us, and T_{f} includes an idle slot duration Tₛₗ at start of T_{f}.

CWₘᵢₙ, p≤CWₚ≤CWₘₐₓ, pe contention window. CWₚ adjustment is described in clause 4.2.2.
C Wₘᵢₙ, pd CWₘₐₓ, pe chosen before step 1 of the procedure above.

mₚ, CWₘᵢₙ, pnd CWₘₐₓ, pe based on a channel access priority class p as shown in Table 4, that is signaled to the UE.

TABLE 4
CAPC for UL

| Channel Access | | | | | |
|---|---|---|---|---|---|
| Priority Class (p) | mₚ | C W_{min,} p | C W_{max,} p | T_{ulm cot, p} | allowed CWₚ sizes |
| 1 | 2 | 3 | 7 | 2 ms | {3, 7} |
| 2 | 2 | 7 | 15 | 4 ms | {7, 15} |
| 3 | 3 | 15 | 1023 | 6 ms or 10 | {15, 31, 63, 127, 255, 511, 1023} |
| | | | | ms | |
| 4 | 7 | 15 | 1023 | 6 ms or 10 | {15, 31, 63, 127, 255, 511, 1023} |
| | | | | ms | |

NOTE1:
For p = 3, 4, T_{ulm cot, p} = 10 ms the higher layer parameter absenceOfAnyOtherTechnology-r14 or absenceOfAnyOtherTechnology-r16 is provided, otherwise, T_{ulm cot, p} = 6 ms
NOTE 2:
When T_{ulm cot, p} = 6 ms may be increased to 8 ms by inserting one or more gaps. The minimum duration of a gap shall be 100 us. The maximum duration before including any such gap shall be 6 ms.

### Type 2 UL Channel Access Procedure

This clause describes channel access procedures by UE where the time duration spanned by the sensing slots that are sensed to be idle before a UL transmission(s) is deterministic.

If a UE is indicated by an eNB to perform Type 2 UL channel access procedures, the UE follows the procedures described in the clause (“Type 2A UL channel access procedure”) below.

### Type 2A UL Channel Access Procedure

If a UE is indicated to perform Type 2A UL channel access procedures, the UE uses Type 2A UL channel access procedures for a UL transmission. The UE may transmit the transmission immediately after sensing the channel to be idle for at least a sensing interval T_{short_ul}=25 us. T_{short_ul} consists of a duration T_{f}=16 us immediately followed by one sensing slot and T_{f} includes a sensing slot at start of T_{f}. The channel is considered to be idle for T_{short_ul} if both sensing slots of T_{short_ul} are sensed to be idle.

### Type 2B UL Channel Access Procedure

If a UE is indicated to perform Type 2B UL channel access procedures, the UE uses Type 2B UL channel access procedure for a UL transmission. The UE may transmit the transmission immediately after sensing the channel to be idle within a duration of T_{f}=16 us. T_{f} includes a sensing slot that occurs within the last 9 us of T_{f}. The channel is considered to be idle within the duration T_{f} if the channel is sensed to be idle for total of at least 5 us with at least 4 us of sensing occurring in the sensing slot.

### Type 2C UL Channel Access Procedure

If a UE is indicated to perform Type 2C UL channel access procedures for a UL transmission, the UE does not sense the channel before the transmission. The duration of the corresponding UL transmission is at most 584 us.

Type 1 DL channel access is used before starting a new COT, where the COT duration can be up to 10 ms depending on traffic priority.

Type 2 DL channel access consists of a deterministic duration of channel sensing where the channel needs to be sensed as idle.
Type 2A channel access allows a transmission if the channel is sensed idle for a least sensing interval of 25 us prior to transmission
Type 2B channel access allows a transmission if the channel is sensed idle for a least sensing interval of 16 us prior to transmission
Type 2C channel access allows a transmission for a duration of no more than 584 us without channel sensing prior to transmission.
Type 2A DL channel access procedures are applicable in shared COT following a UE transmission and for transmissions that consist of discovery burst with duration of most 1 ms and duty cycle at most 1/20.
Type 2B or Type 2C DL channel access procedures are applicable following transmission(s) by a UE after a gap of 16 us or up to 16 us, respectively, in a shared channel occupancy.

Similarly with DL access channel types, in UL channel access procedures, Type 1 UL access is based on sensing channel idle for a defer duration Td and random backoff counter N as in Type 1A DL, Type 2 UL consists of deterministic duration idle channel before transmissions, Type 2A UL of at least 25 us channel idle, Type 2B UL of at least 16 us channel idle, and Type 2C no sensing for transmissions of at most 584 us.

There is no sidelink specification in shared spectrum (SL-U) in current systems. It is expected that the SL-U follows the NR-U channel access specified in TS 37.213. Moreover, it is expected that that SL-U reuses the SL resource allocation methods as much as possible.

The SL resource selection specification does not consider the LBT (channel assessment (CA)) necessary prior to a transmission or the case when the LBT prior to a transmission fails and therefore the transmission cannot be performed.

In this disclosure, the term SL-U UE may be used to identify a sidelink UE that operates in unlicensed (shared) spectrum. More precisely, embodiments in this disclosure identify and solve the technical limitations that LBT imposes on the SL resource selection and reservation, the impact of out of network interference and transmissions (specific to shared spectrum) on SL resource selection, and the impact of out of network interference on the congestion control used in SL.

In Mode 2, the SL-U UE autonomously selects resources for transmission and may assist other SL-U UEs for their resource selection (for instance using inter UE coordination (IUC)). For this mode, the upper layers provide the lower layer the CAPC value for the channel access priority used in channel access mechanism (adaptivity).

First, regarding the usage of the CAPC and SL priorities, they are used for different purposes and have different time scales.

The CAPC is used for LBT sensing COT maximum duration. The timing for LBT (based on CAPC values) is very short on the order of tens to no more than few hundreds of microseconds for 5 GHz bands, which may be equivalent one or few OFDM symbols duration. For instance, when the value of CAPC=1, the LBT duration (when successful) corresponds to a sensing slot duration (9 us) plus the backoff period duration (between 3×9 and 7×9 us), i.e., less than 73 us. The subcarrier spacing values of {15, 30, 60, 120} kHz correspond to the OFDM symbol duration of {66.7, 33.3, 16.7, 8.33} us.

The purpose of SL resource reservation is to reserve some resources for future transmissions. It is noted that these reservations are made only in the SL resources (a subset of UL resources), and the reservations are decoded and respected only by the SL UE devices, which can decode SCI (sidelink control information). The reservation methodology is specified by 3GPP and followed only by the 3GPP devices that implement this feature. The channel access however (based on CAPC) is mandated for any type of device (thus non-3GPP) that operate in EU 5 GHz unlicensed bands and is specified by ETSI.

The durations of SL resource reservation windows are much longer than the channel access LBT, the SL sensing window 202 is up to 100 ms, while the resource selection window 204 duration is T2−T1 (e.g., in FIG. 2), where T1 can be as low as zero and T2 min include {1, 5, 10, 20}*2\hat{ }mu slots, where mu values {0,1,2,3} correspond to SCS values of {15, 30, 60, 120} kHz. This results in durations equal to {1, 5, 10, 20} ms.

The main difference between licensed and shared spectrum (or unlicensed spectrum) is that in shared spectrum, out of network transmissions can take place. These transmissions may be under different Radio Access Technology (RAT), and therefore cannot necessarily be decoded. Therefore, during the SL sensing window 202 some transmissions (such as WiFi) can take place and an SL-U UE may be unable to decode the transmission or measure a corresponding RSRP. This situation can affect the way the candidate list is constructed. The unlicensed spectrum/band can be spectrum/band for WiFi, Bluetooth, or NR-U (e.g. 5 unlicensed band, 6 GHz spectrum etc.).

Another difference is that prior to a transmission an LBT procedure may be initiated, which may impact the latency.

In an embodiment, T_{proc,1}, which now can be zero, in the selection window 204 cannot be smaller than the (minimum or maximum) LBT duration.

The LBT procedure may be required before a transmission takes place. In this case, in another embodiment, when LBT fails a re-evaluation of resource selection may be triggered.

In some embodiments, another way to deal with LBT failures is to allow multiple resource selections (reservations) for the same transmission. In this case if the LBT is successful, the SL-U UE may cancel (de-select) via SCI future reservations. For instance, a bit in SCI format 1-A may indicate that all (or a limited number of) future reservations corresponding to resource reservation period are cancelled so those resources become available for other SL-U UE to select. The cancellation of future reservation may occur only after the acknowledgement from the receiver that the transmission went through. It is expected that such procedure to be used more in unicast communications but can be adapted for multicast too. For instance, future retransmissions may be cancelled when a minimum number of acknowledgements was received (HARQ ACK/NACK).

In some embodiments, where there are multiple reserved resources for retransmissions, the LBT failure will trigger a re-evaluation procedure of the resource selection only if all the LBTs prior to a transmission and retransmission reservation fail.

The LBT failure may be an important measure that can be used for resource selection and reservation.

In one embodiment, if an SL UE observes (determines) a consistent LBT failure on a set of resources (frequency channels, slots, periodic resources, etc.), it may exclude those resources from the resource selected set or considered for resource selection with a lower priority. In some embodiments, it may consider those resources as non-preferred resources in the Inter UE Coordination procedure.

Consistent LBT failure on some resources may be defined for instance when the number of LBT failures on those resources during an observing (measuring) window in the recent past is above some (pre-)configured threshold. The observation window may be a separate (pre-)configuration, equal to a (pre-)configured sensing or resource selection window, equal to a multiple or other function of a (pre-)configured sensing or resource selection window, or equal to or a multiple of a maximum or minimum sensing window or resource selection window.

In some embodiments, if the number of successful LBTs procedures on some resources in a recent observing window was above a threshold, those resources may be considered for resource selection with higher priority or considered as be part of the preferred resource list in the IUC procedure.

In some embodiments, an SL-U UE is capable of monitoring during the sensing window 202 of the received signal energy indication (RSSI) in each of the symbols of the slot. When the RSSI is high but SL-U UE is not capable to decode a SCI, SL-U UE determines that a non-SL RAT transmission is received. In FIG. 3, there is no non-SL RAT (e.g., WiFi). The Uu link between the gNB 302 and the UE 304 is non-SL. However, transmissions between the gNB 302 and the UE 304 being under the control of the gNB 302 would not interfere with the SL transmissions between the UEs 304 and 306, which operate in a subset of UL slots. There are no PC5 links between a gNB and a UE. However, PC5 links may be used between a road side unit (RSU) and a UE. Non-SL RAT transmission can be any RAT transmission other than SL-RAT transmission, for example WiFi transmission, Bluetooth transmission, or NR-U transmission.

In an embodiment, an SL-U UE monitors the sensing window 202 and collects the RSSI for each slot (symbol), decodes the SCI (if any), and measures the RSRP (if possible). If SL-U UE fails to decode a SCI but the measured RSSI is larger than a (pre-)configured threshold (such as CABR_Threshold, described more in details below), the UE will collect a (long-term) statistic of the corresponding availability of one or more resources (over time) in the unlicensed band/spectrum to be further used for the selection of preferred and/or non-preferred resources that can be used in the Inter UE Coordination (IUC) process. For instance, a resource that is consistently occupied by another RAT transmission may be qualified as non-preferred resources and sent to other UEs in the IUC procedure.

In some embodiments, the results of the statistics are used by SL-U UE for resource selection in the unlicensed band/spectrum. For instance, if a resource is occupied occasionally by another RAT transmission (or just strong noise) it can be used as selected resource for future reservation. However, if the same resource is consistently occupied by another RAT transmission (or noise), it may be excluded from the selected resource list. The another RAT may be one or more RATs in the unlicensed band different than a SL unlicensed transmission. For example, the another RAT may include WiFi, NR-U, Bluetooth, etc.

Moreover, the candidates that would correspond to any periodicity value allowed by the higher layer parameter for a resource reservation period in hypothetical SCI format 1-A received in that slot will not be excluded from the potential candidate list.

A UE may or may not be required to perform an LBT prior to its transmissions that take place either at a reserved resource or without reservation.

Examples where transmissions may not require an LBT procedure (channel sensing):
if there is a short control transmission (with a short duration as specified by 3GPP NR-U and ETSI BRAN specs) (Type 2C),
if there is a transmission in a shared COT that immediately follows another transmission in the same COT.

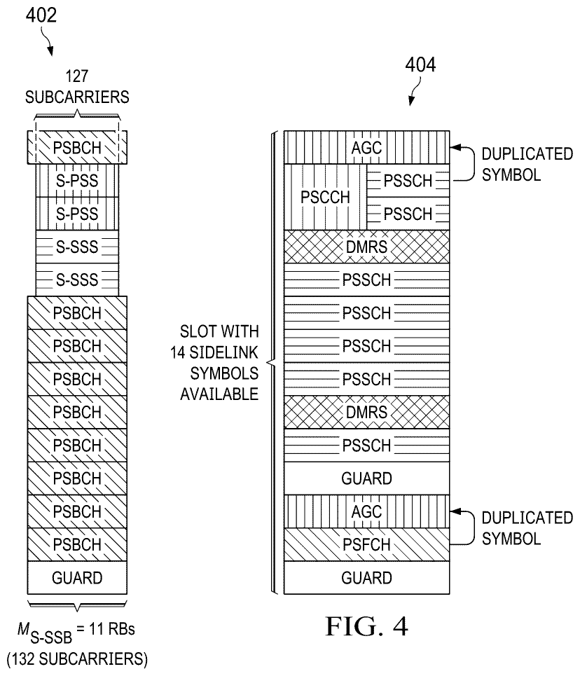

It is noted that the SL transmissions are slot based. An example of such transmission is in the FIG. 4 (Sidelink Synchronization Signal/Physical Broadcast Channel block (S-SSB) and respectively PSSCH), according to some embodiments.

FIG. 4 shows two examples of SL legacy slots. The slot 402 shows the S-SSB slot format, and the slot 404 shows the SL data (PSCCH and PSSCH) slot format. In FIG. 4, an SL slot (e.g., the slot 402 or 404) is ending with a guard symbol, where there is no transmission. Therefore, it seems that always there is gap (of one slot) between two consecutive transmissions. To avoid the LBT between consecutive transmissions, embodiments of this disclosure provide the following solutions, which are based on transmitting during the guard symbol to avoid gaps.

When the same SL UE reserves two or more consecutive slots for consecutive transmissions, the SL UE may retransmit in the last symbol one of the previous symbols such that will avoid the gap.

When the SL UE reserves (schedules) a PSFCH transmission prior to the last symbol (as in FIG. 4), the originator SL UE may indicate to the responder SL UE that it will transmit PSFCH to extend its transmission during the guard symbol so a continuity of transmissions to the next slot is achieved.

In another embodiment, for the same scenario, the originator SL UE may also indicate the guard symbol between PSSCH and PSFCH will be filled with some repetition, so the responder does not need to execute an LBT.

In some embodiments, when an SL UE that initiates a COT shares a COT with a responder SL UE it may indicate to the responder either the initiator extends transmission at the end of its transmission during its guard symbol, or the responder should extend its transmission at the end of its slot during the guard symbol.

Yet, in some embodiments, instead of the originator or the COT initiator UE to extend the transmission during the guard symbol, the receiver or the responder UE may start their transmission rather earlier with one symbol to avoid doing LBT.

Examples where transmissions may require LBT procedure (channel sensing):
when transmission requires to initiate a COT (Type 1),
when transmission in in a shared COT with a gap with respect to previous transmission (for instance Type 1, Type 2 A, Type 2B)

When the LBT fails prior to a transmission, the transmission cannot take place. In that case, the SL UE waits for the next opportunity to transmit. The next opportunity to transmit may be next resource reservation either periodic reservation or retransmission reservation or an opportunity for dynamic transmission (no reservation necessary).

CBR and CR are important measures for congestion management and selection of a transmission parameters as presented above. CBR and CR definitions assume that the only transmissions that takes place are the SL transmissions. In shared spectrum this is not the case and other RAT transmissions may be received, for instance WiFi. These out of the network RAT transmissions may negatively affect the parameter selection for further transmissions.

Embodiments in this disclosure provide technical solutions to distinguish between strong signals (energy) received from SL-U transmissions and non-SL-U transmissions.

To identify a non-SL RAT transmission, an SL UE may observe the SL pools of resource.

This disclosure distinguishes a few cases:
1) An SL transmission is recognized (for instance, by decoding the SCI).
2) An SL transmission is not recognized, and the received energy (e.g., non-SL RSSI) in the channel is low.
3) An SL transmission is not recognized, and the received energy (e.g., non-SL RSSI) is high.

For the case 3) the observing SL UE may conclude that there is a non-SL RAT transmission. That is, even the resource pool is allocated to SL transmissions there other than SL devices that transmit in those resources.

This disclosure identifies two parts in the above cases. The first part is to recognize an SL transmission, which can be achieved by just monitoring the first two symbols of the slot. The second part, which is done when there is a non-SL transmission is to measure the received non-SL RSSI. This received non-SL RSSI is not as the SL RSSI which is measured on SL RS strength.

The received non-SL RSSI may be measured in multiple ways, for instance, in just the first two symbols and based on its value decide that entire slot is going to be removed as an SL pool opportunity. Another option is to measure non-SL RSSI in each of the slot symbols and decide if there is no-SL RAT transmission in that slot. Yet another option is to measure RSSI in a subset of symbols of slot, or just in a particular symbol such as the guard symbol.

The SL decoding and non-SL RSSI measurements of the channel may be executed at the same symbols or in consecutive symbols.

One purpose of the embodiments in this disclosure is to identify non-SL RAT transmissions, which are considered occupied resources and to exclude them from the congestion control measures.

Therefore, embodiments of this disclosure provide two thresholds and define an additional measure to CBR.

More precisely, embodiments of this disclosure exclude from CBR measure those slots or resources that are occupied by transmissions outside of SL UE RAT, such as WiFi. The new described measure (metric) named Channel Access Busy Ratio (CABR) corresponds the portion of SL sub-channels in the resource pool where either there are SL transmissions or non-SL transmissions RSSI is below a CABR_Threshold. This threshold required for this measure may be (pre-)configured. The threshold may be the same or different of the energy detection threshold (EDT) required for LBT prior transmission.

The new measurement of CABR may be configured, requested, and reported to gNB or higher layer(s) of the SL-U UE to be used for channel statistics, and resource selection, as non-preferred resource for instance.

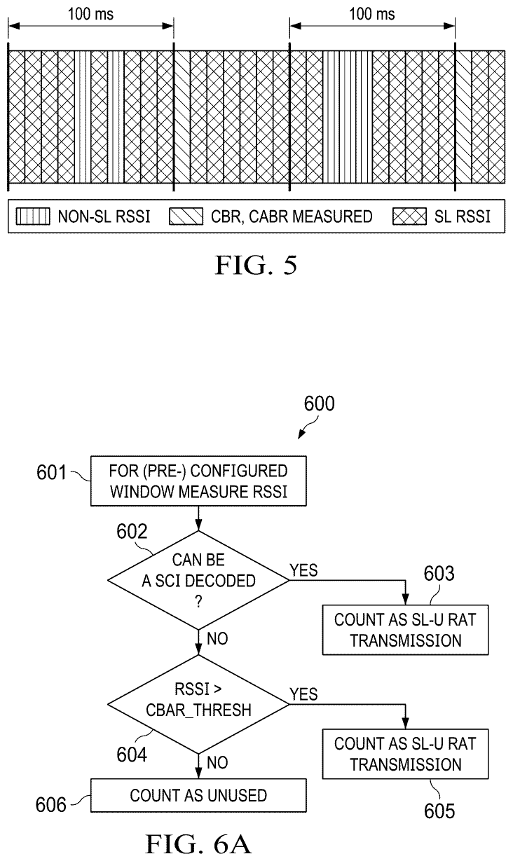

The measuring window for CABR may be the same or different from the CBR measuring window. As shown in FIG. 5, the measuring (observing) window is 100 ms for instance.

Based on the same techniques, a new measure (metric) of CR may be defined for SL unlicensed deployment.

In one embodiment the existing CR and CBR definitions are changed to exclude those resources “corrupted” by other RAT transmissions or strong noise.

For instance, the definition of CR in TS 38.215,
Sidelink Channel Occupancy Ratio (SL CR) evaluated at slot n is defined as the total number of sub-channels used for its transmissions in slots [n−a, n−1] and granted in slots [n, n+b] divided by the total number of configured sub-channels in the transmission pool over [n−a, n+b].
   may be changed to
Sidelink Channel Occupancy Ratio (SL CR) evaluated at slot n is defined as the total number of sub-channels used for its transmissions in slots [n−a, n−1] where either an SL transmission is received or the average received non-SL RSSI is less than CABR_Threshold and granted in slots [n, n+b] divided by the total number of configured sub-channels in the transmission pool over [n−a, n+b] where either an SL transmission is received or the average received non-SL RSSI is less than CABR_Threshold.

Without changing the CR definition, the SL CR metric may falsely count the transmissions from another RAT in shared channel as non-used (empty) resources. For instance, if 20% of the slots in [n−a, n−1] slot interval are occupied by other RAT (non SL UE RAT) transmissions, it means that there are no SL UE transmissions in those 20% of resources, however based on the existing definitions they will be counted as SL unoccupied slots, which will make CR smaller. If CR is inaccurate, the resource allocation may be too aggressive, which generates collisions with other RAT transmissions (like WiFi). Therefore, these non-SL UE RAT transmissions slots should be removed from counting in the CR definition.

In some embodiments, a new metric may be defined based on the previous remarks. Embodiments of this disclosure define the new measure CR-U (CR-unlicensed), where CR-U evaluated at slot n is defined as the total number of sub-channels used for its transmissions in slots [n−a, n−1] and granted in slots [n, n+b] divided by the total number of configured sub-channels in the transmission pool over [n−a, n+b] except the slots occupied by non-SL RAT transmissions.

As above, the slots occupied by non-SL RAT transmissions may be defined as those slots where non-SL RSSI is above CABR_Threshold and a SL-U UE fails to decode as an SL transmissions.

Like CR, below is an example of the CBR definition:
SL Channel Busy Ratio (SL CBR) measured in slot n is defined as the portion of sub-channels in the resource pool whose SL RSSI measured by the UE exceed a (pre-)configured threshold sensed over a CBR measurement window [n−a, n−1],wherein a is equal to 100 or 100·2^{μ} slots, according to higher layer parameter sl-TimeWindowSizeCBR. When UE is configured to perform partial sensing by higher layers (including when SL DRX is configured), SL RSSI is measured in slots where the UE performs partial sensing and where the UE performs PSCCH/PSSCH reception within the CBR measurement window. The calculation of SL CBR is limited within the slots for which the SL RSSI is measured. If the number of SL RSSI measurement slots within the CBR measurement window is below a (pre-)configured threshold, a (pre-)configured SL CBR value is used.
   may be changed to
SL Channel Busy Ratio (SL CBR) measured in slot n is defined as the portion of sub-channels in the resource pool whose SL RSSI measured by the UE exceed a (pre-)configured threshold sensed over a CBR measurement window [n−a, n−1], wherein a is equal to 100 or 100·2^{μ} slots, according to higher layer parameter sl-TimeWindowSizeCBR. Where the resource pool is defined as the resource pool where either SL transmissions take place or received non-SL RSSI is less than the CABR_Threshold. When UE is configured to perform partial sensing by higher layers (including when SL DRX is configured), SL RSSI is measured in slots where the UE performs partial sensing and where the UE performs PSCCH/PSSCH reception within the CBR measurement window. The calculation of SL CBR is limited within the slots for which the SL RSSI is measured. If the number of SL RSSI measurement slots within the CBR measurement window is below a (pre-configured threshold, a (pre-)configured SL CBR value is used.

The same possible bias in the existing definition of SL CBR. If the ratio (portion) is considered with respect to the SL resource pool, without considering the non-SL occupied resources, the SL CBR may be inaccurate. Therefore, those resources occupied by other types of transmissions (non SL) may be excluded.

The CABR and CR-U are calculated over a (pre-)configured time window of selected SL resources, for instance over the sensing window 202 and/or the selection window 204.

In an embodiment, the new defined CR-U measure/metric is used to update the CR table defined above, where CR limit values are replaced with CR-U limit values and use the new limits for resource allocation.

IUC for SL-U should consider using the new defined metrics of channel occupancy as well as long term statistics of the resources occupied by other RAT transmissions.

In the IUC procedure the list of preferred resources excludes those resources that overlap with reserved resource(s) indicated by a received SCI format 1-A whose RSRP measurement is higher than an RSRP threshold.

In an embodiment, the preferred resources, in addition to above, may exclude resources corresponding non-SL RAT transmission that meet some long-term statistics constraint.

For instance, the preferred resources may exclude those resources where it was detected non-SL RAT transmissions with the average non-SL RSSI larger than the preferred non-SL RSSI threshold, where the threshold can be (pre-)configured. This threshold may or may not be the same as CABR_Threshold.

In addition, to the conditions already defined by specs, in an embodiment, in the set of the non-preferred resources it may be added those resources identified as non-SL RAT transmissions that satisfy some long-term statistics constraint. Such long-term statistics, for instance, may be the condition that the average non-SL RSSI is larger than a non-preferred non-SL RSSI threshold, which can be (pre-)defined.

For resources with conflicts, the list may include those resources reserved in the future that would overlap with some of the non-preferred resources identified based on received non-SL RSSI long term statistics of the non-SL RAT transmissions.

In some embodiments, based on the number (frequency of occurrences) of non-SL RAT transmissions and/or the received non-SL RSSI for such transmissions observed during an observing window, those resources may be ranked with different priorities, which may be sued for resource selection.

For instance, if the non-SL RSSI for non-SL transmissions>Threshold 1, the priority is very low in resource selection, if the non-SL RSSI for non-SL transmissions>Threshold 2 and <Threshold 1 the priority of those resources in the resource selection is medium, etc. These thresholds may be (pre-)configured by gNB for instance.

The above concepts may be extended straightforward for partial sensing, and periodic partial sensing, for which, new non-SL RSSI thresholds used in the long-term statistics calculations are defined.

All the above measurements and statistics may be reported to gNB either per request or when some conditions are satisfied. Example of such condition, if the CABR or CR-U measures become higher or lower than some thresholds.

Moreover, in some embodiments the SL UE may keep track and measure the resources occupied by non-SL transmissions and report them either by request or trigger by some event. The configurations for acquiring these measures and statistics such collection window, set of symbols and resources, or thresholds for non-SL RSSI may be (pre-)configured.

The non-SL RSSI measurement may be done in various ways. In one way, the measurement is implemented like the channel sensing done during LBT procedure. For instance, using a Ts (sensing slot) of 9 us in the 5 GHz band. For instance, the NL-SL RRSI measurement could take place at the beginning of each symbol for a duration of a number of sensing slots (Ts). The so-called sensing slot Ts is much shorter than the duration of OFDM symbol and obviously much shorter than the duration of a NR slot (14 OFDM symbols). Yet in some embodiments, the non-SL RSSI measurement can last a number of sensing slots (Ts) anywhere during an OFDM slot, where they location can be uniformly spread, or at the end of the slot or left to the implementation.

As was mentioned in this disclosure, before a transmission a UE may be required to execute an LBT procedure. During the LBT procedure, it may happen that the channel is found busy (LBT sensing procedure being described for instance in TS 37.213 and presented above). When the channel is found busy or available for transmission, the UE that executes the LBT procedure could collect this information and included in the long-term statistics associated with the SL resource pool availability. In other words, the non-SL RSSI measurements defined above, are collected not only in the sensing window 202 in FIG. 2 used for resource pool evaluation but also collected during the selection window 204 where the transmissions will take place.

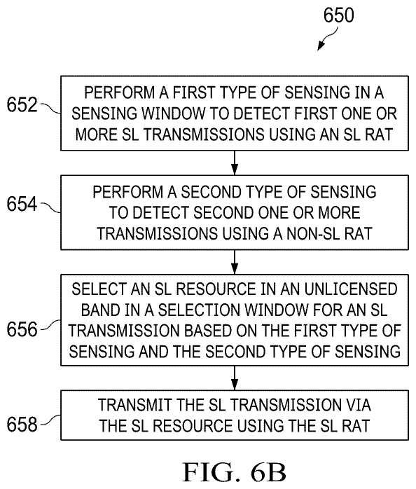

FIG. 6A shows a flow chart 600 for the resource reservation of an SL UE, according to some embodiments. At the operation 601, the UE measures the RSSI in a (pre-)configured window. At the operation 602, the UE determines whether an SCI can be decoded. If so, the resource(s) are counted as occupied by SL-U RAT transmission at the operation 603. If not, at the operation 604, the UE determines whether the measured RSSI is greater than a CBAR threshold. If the measured RSSI is greater than the CBAR threshold, the resource(s) are counted as occupied by non-SL-U RAT transmission at the operation 605; otherwise, the resource is counted as unused at the operation 606.

FIG. 6B shows a flow chart of a method 650 performed by a UE for SL resource reservation, according to some embodiments. The UE may include computer-readable code or instructions executing on one or more processors of the UE. Coding of the software for carrying out or performing the method 650 is well within the scope of a person of ordinary skill in the art having regard to the present disclosure. The method 650 may include additional or fewer operations than those shown and described and may be carried out or performed in a different order. Computer-readable code or instructions of the software executable by the one or more processors may be stored on a non-transitory computer-readable medium, such as for example, the memory of the UE.

The method 650 starts at the operation 652, where the UE performs a first type of sensing in a sensing window to detect first one or more SL transmissions in an unlicensed band using a sidelink (SL) radio access technology (RAT). At the operation 654, the UE performs a second type of sensing to detect second one or more transmissions in the unlicensed band using a non-SL RAT different from the SL RAT. The second type is different from the first type. At the operation 656, the UE selects an SL resource in the unlicensed band in a selection window for an SL transmission based on the first type of sensing and the second type of sensing. At the operation 658, the UE transmits the SL transmission via the SL resource using the SL RAT.

In some embodiments, the non-SL RAT may comprise a wireless fidelity (WiFi) RAT.

In some embodiments, to perform the first type of sensing, the UE may receive a sidelink control information (SCI), decode the SCI, and measure a reference signal received power (RSRP) based on the SCI to determine first one or more occupied resources in the unlicensed band. In some embodiments, the UE may exclude the first one or more occupied resources from a set of resources for selecting the SL resource.

In some embodiments, to perform the second type of sensing, the UE may detect a decoding failure during the performing the first type of sensing, perform a clear channel assessment (CCA) procedure, and measure a received signal strength indicator (RSSI) during the CCA procedure to identify second one or more occupied resources in the unlicensed band sensed by the CCA procedure. In some embodiments, the UE may exclude the second one or more occupied resources from a set of resources used for candidate selection based on the decoding failure and the RSSI. The set of resources for candidate selection is used for selecting the SL resource, which may be a set of candidate resources or a list of candidate resources. In some embodiments, the UE may exclude the second one or more occupied resources from the set of resources for candidate selection based on the decoding failure and the RSSI below a threshold. In some embodiments, to measure the RSSI, the UE may measure the RSSI in at least one symbol in an SL slot or in a fraction of time of each of the at least one symbol in the SL slot.

In some embodiments, the selection window may be no earlier than a listen before talk (LBT) duration of a LBT procedure.

In some embodiments, the UE may determine possible future resources that may be occupied based on the first type of sensing and the second type of sensing. The UE may exclude the possible future resources from the set of resources used for candidate selection.

In some embodiments, the UE may determine a channel access busy ratio (CABR) corresponding to a portion of SL sub-channels occupied by the first one or more SL transmissions only or by the second one or more transmissions only in a SL resource pool. The UE may perform SL congestion control based on the CABR.

In some embodiments, the UE may determine a channel busy ratio (CBR) corresponding to a portion of SL sub-channels occupied by the first one or more SL transmissions only or by the second one or more transmissions only in a SL resource pool. The UE may perform SL congestion control based on the CBR.

In some embodiments, the UE may collect statistic of an availability of a resource occupied by a RAT transmission. A result of the statistic is used for selecting at least one of a preferred resource or non-preferred resource to be used in an IUC process. In some embodiments, the UE may collect an RSRP for one or more symbols of the sensing window. The UE may decode an SCI. Collecting the statistics of the availability of the resource may be performed when the UE fails to decode the SCI and the RSSI is larger than a threshold.

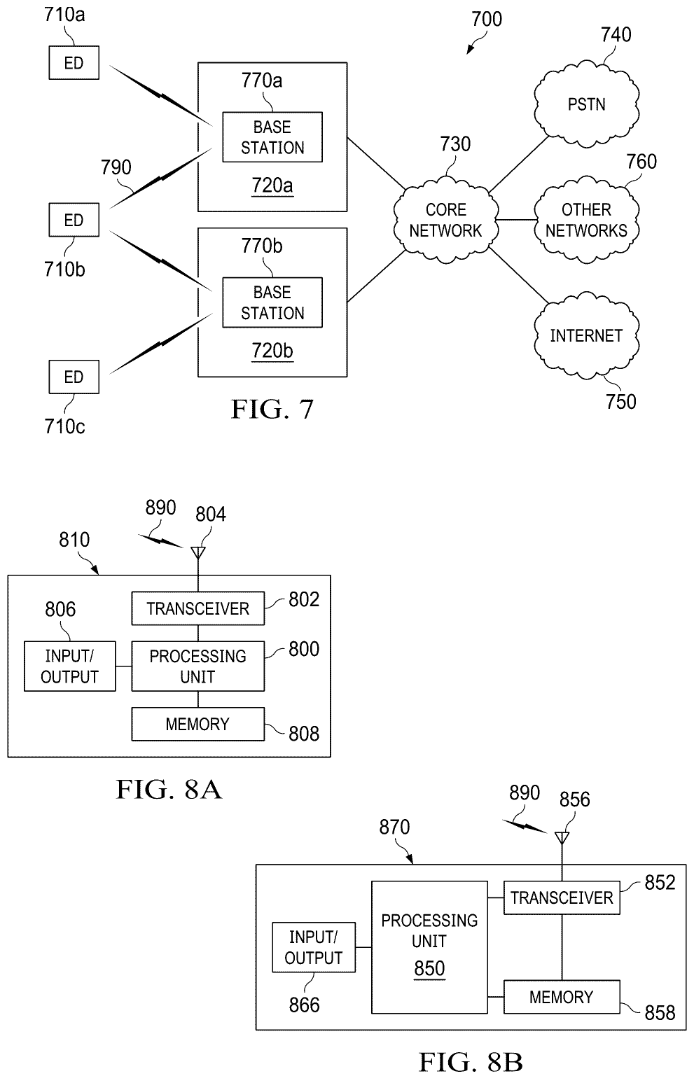

FIG. 7 illustrates an example communication system 700. In general, the system 700 enables multiple wireless or wired users to transmit and receive data and other content. The system 700 may implement one or more channel access methods, such as code division multiple access (CDMA), time division multiple access (TDMA), frequency division multiple access (FDMA), orthogonal FDMA (OFDMA), single-carrier FDMA (SC-FDMA), or non-orthogonal multiple access (NOMA).

In this example, the communication system 700 includes electronic devices (ED) 710a-710c, radio access networks (RANs) 720a-720b, a core network 730, a public switched telephone network (PSTN) 740, the Internet 750, and other networks 760. While certain numbers of these components or elements are shown in FIG. 7, any number of these components or elements may be included in the system 700.

The EDs 710a-710c are configured to operate or communicate in the system 700. For example, the EDs 710a-710c are configured to transmit or receive via wireless or wired communication channels. Each ED 710a-710c represents any suitable end user device and may include such devices (or may be referred to) as a user equipment or device (UE), wireless transmit or receive unit (WTRU), mobile station, fixed or mobile subscriber unit, cellular telephone, personal digital assistant (PDA), smartphone, laptop, computer, touchpad, wireless sensor, or consumer electronics device.

The RANs 720a-720b here include base stations 770a-770b, respectively. Each base station 770a-770b is configured to wirelessly interface with one or more of the EDs 710a-710c to enable access to the core network 730, the PSTN 740, the Internet 750, or the other networks 760. For example, the base stations 770a-770b may include (or be) one or more of several well-known devices, such as a base transceiver station (BTS), a Node-B (NodeB), an evolved NodeB (eNodeB), a Next Generation (NG) NodeB (gNB), a Home NodeB, a Home eNodeB, a site controller, an access point (AP), or a wireless router. The EDs 710a-710c are configured to interface and communicate with the Internet 750 and may access the core network 730, the PSTN 740, or the other networks 760.

In the embodiment shown in FIG. 7, the base station 770a forms part of the RAN 720a, which may include other base stations, elements, or devices. Also, the base station 770b forms part of the RAN 720b, which may include other base stations, elements, or devices. Each base station 770a-770b operates to transmit or receive wireless signals within a particular geographic region or area, sometimes referred to as a “cell.” In some embodiments, multiple-input multiple-output (MIMO) technology may be employed having multiple transceivers for each cell.

The base stations 770a-770b communicate with one or more of the EDs 710a-710c over one or more air interfaces 790 using wireless communication links. The air interfaces 790 may utilize any suitable radio access technology.

It is contemplated that the system 700 may use multiple channel access functionality, including such schemes as described above. In particular embodiments, the base stations and EDs implement 5G New Radio (NR), LTE, LTE-A, or LTE-B. Of course, other multiple access schemes and wireless protocols may be utilized.

The RANs 720a-720b are in communication with the core network 730 to provide the EDs 710a-710c with voice, data, application, Voice over Internet Protocol (VOIP), or other services. Understandably, the RANs 720a-720b or the core network 730 may be in direct or indirect communication with one or more other RANs (not shown). The core network 730 may also serve as a gateway access for other networks (such as the PSTN 740, the Internet 750, and the other networks 760). In addition, some or all of the EDs 710a-710c may include functionality for communicating with different wireless networks over different wireless links using different wireless technologies or protocols. Instead of wireless communication (or in addition thereto), the EDs may communicate via wired communication channels to a service provider or switch (not shown), and to the Internet 750.

Although FIG. 7 illustrates one example of a communication system, various changes may be made to FIG. 7. For example, the communication system 700 could include any number of EDs, base stations, networks, or other components in any suitable configuration.

FIGS. 8A and 8B illustrate example devices that may implement the methods and teachings according to this disclosure. In particular, FIG. 8A illustrates an example ED 810, and FIG. 8B illustrates an example base station 870. These components could be used in the system 700 or in any other suitable system.

As shown in FIG. 8A, the ED 810 includes at least one processing unit 800. The processing unit 800 implements various processing operations of the ED 810. For example, the processing unit 800 could perform signal coding, data processing, power control, input/output processing, or any other functionality enabling the ED 810 to operate in the system 700. The processing unit 800 also supports the methods and teachings described in more detail above. Each processing unit 800 includes any suitable processing or computing device configured to perform one or more operations. Each processing unit 800 could, for example, include a microprocessor, microcontroller, digital signal processor, field programmable gate array, or application specific integrated circuit.

The ED 810 also includes at least one transceiver 802. The transceiver 802 is configured to modulate data or other content for transmission by at least one antenna or NIC (Network Interface Controller) 804. The transceiver 802 is also configured to demodulate data or other content received by the at least one antenna 804. Each transceiver 802 includes any suitable structure for generating signals for wireless or wired transmission or processing signals received wirelessly or by wire. Each antenna 804 includes any suitable structure for transmitting or receiving wireless or wired signals. One or multiple transceivers 802 could be used in the ED 810, and one or multiple antennas 804 could be used in the ED 810. Although shown as a single functional unit, a transceiver 802 could also be implemented using at least one transmitter and at least one separate receiver.

The ED 810 further includes one or more input/output devices 806 or interfaces (such as a wired interface to the Internet 750). The input/output devices 806 facilitate interaction with a user or other devices (network communications) in the network. Each input/output device 806 includes any suitable structure for providing information to or receiving information from a user, such as a speaker, microphone, keypad, keyboard, display, or touch screen, including network interface communications.

In addition, the ED 810 includes at least one memory 808. The memory 808 stores instructions and data used, generated, or collected by the ED 810. For example, the memory 808 could store software or firmware instructions executed by the processing unit(s) 800 and data used to reduce or eliminate interference in incoming signals. Each memory 808 includes any suitable volatile or non-volatile storage and retrieval device(s). Any suitable type of memory may be used, such as random access memory (RAM), read only memory (ROM), hard disk, optical disc, subscriber identity module (SIM) card, memory stick, secure digital (SD) memory card, and the like.

As shown in FIG. 8B, the base station 870 includes at least one processing unit 850, at least one transceiver 852, which includes functionality for a transmitter and a receiver, one or more antennas 856, at least one memory 858, and one or more input/output devices or interfaces 866. A scheduler, which would be understood by one skilled in the art, is coupled to the processing unit 850. The scheduler could be included within or operated separately from the base station 870. The processing unit 850 implements various processing operations of the base station 870, such as signal coding, data processing, power control, input/output processing, or any other functionality. The processing unit 850 can also support the methods and teachings described in more detail above. Each processing unit 850 includes any suitable processing or computing device configured to perform one or more operations. Each processing unit 850 could, for example, include a microprocessor, microcontroller, digital signal processor, field programmable gate array, or application specific integrated circuit.

Each transceiver 852 includes any suitable structure for generating signals for wireless or wired transmission to one or more EDs or other devices. Each transceiver 852 further includes any suitable structure for processing signals received wirelessly or by wire from one or more EDs or other devices. Although shown combined as a transceiver 852, a transmitter and a receiver could be separate components. Each antenna 856 includes any suitable structure for transmitting or receiving wireless or wired signals. While a common antenna 856 is shown here as being coupled to the transceiver 852, one or more antennas 856 could be coupled to the transceiver(s) 852, allowing separate antennas 856 to be coupled to the transmitter and the receiver if equipped as separate components. Each memory 858 includes any suitable volatile or non-volatile storage and retrieval device(s). Each input/output device 866 facilitates interaction with a user or other devices (network communications) in the network. Each input/output device 866 includes any suitable structure for providing information to or receiving/providing information from a user, including network interface communications.

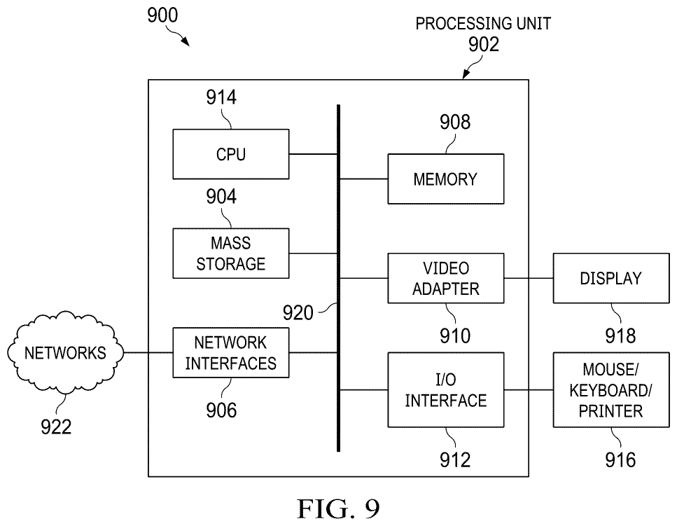

FIG. 9 is a block diagram of a computing system 900 that may be used for implementing the devices and methods disclosed herein. For example, the computing system can be any entity of UE, access network (AN), mobility management (MM), session management (SM), user plane gateway (UPGW), or access stratum (AS). Specific devices may utilize all of the components shown or only a subset of the components, and levels of integration may vary from device to device. Furthermore, a device may contain multiple instances of a component, such as multiple processing units, processors, memories, transmitters, receivers, etc. The computing system 900 includes a processing unit 902. The processing unit includes a central processing unit (CPU) 914, memory 908, and may further include a mass storage device 904, a video adapter 910, and an I/O interface 912 connected to a bus 920.

The bus 920 may be one or more of any type of several bus architectures including a memory bus or memory controller, a peripheral bus, or a video bus. The CPU 914 may comprise any type of electronic data processor. The memory 908 may comprise any type of non-transitory system memory such as static random access memory (SRAM), dynamic random access memory (DRAM), synchronous DRAM (SDRAM), read-only memory (ROM), or a combination thereof. In an embodiment, the memory 908 may include ROM for use at boot-up, and DRAM for program and data storage for use while executing programs.

The mass storage 904 may comprise any type of non-transitory storage device configured to store data, programs, and other information and to make the data, programs, and other information accessible via the bus 920. The mass storage 904 may comprise, for example, one or more of a solid state drive, hard disk drive, a magnetic disk drive, or an optical disk drive.

The video adapter 910 and the I/O interface 912 provide interfaces to couple external input and output devices to the processing unit 902. As illustrated, examples of input and output devices include a display 918 coupled to the video adapter 910 and a mouse, keyboard, or printer 916 coupled to the I/O interface 912. Other devices may be coupled to the processing unit 902, and additional or fewer interface cards may be utilized. For example, a serial interface such as Universal Serial Bus (USB) (not shown) may be used to provide an interface for an external device.

The processing unit 902 also includes one or more network interfaces 906, which may comprise wired links, such as an Ethernet cable, or wireless links to access nodes or different networks. The network interfaces 906 allow the processing unit 902 to communicate with remote units via the networks. For example, the network interfaces 906 may provide wireless communication via one or more transmitters/transmit antennas and one or more receivers/receive antennas. In an embodiment, the processing unit 902 is coupled to a local-area network 922 or a wide-area network for data processing and communications with remote devices, such as other processing units, the Internet, or remote storage facilities.

It should be appreciated that one or more steps of the embodiment methods provided herein may be performed by corresponding units or modules. The respective units or modules may be hardware, software, or a combination thereof. For instance, one or more of the units or modules may be an integrated circuit, such as field programmable gate arrays (FPGAs) or application-specific integrated circuits (ASICs).

Although the description has been described in detail, it should be understood that various changes, substitutions and alterations can be made without departing from the spirit and scope of this disclosure as defined by the appended claims. Moreover, the scope of the disclosure is not intended to be limited to the particular embodiments described herein, as one of ordinary skill in the art will readily appreciate from this disclosure that processes, machines, manufacture, compositions of matter, means, methods, or steps, presently existing or later to be developed, may perform substantially the same function or achieve substantially the same result as the corresponding embodiments described herein. Accordingly, the appended claims are intended to include within their scope such processes, machines, manufacture, compositions of matter, means, methods, or steps.

What is claimed is:

1. A method, comprising:
performing, by a user equipment (UE), a first type of sensing in a sensing window to detect first one or more sidelink (SL) transmissions in an unlicensed band using an SL radio access technology (RAT);
performing, by the UE, a second type of sensing to detect second one or more transmissions in the unlicensed band using a non-SL RAT different from the SL RAT, the second type being different from the first type;
selecting, by the UE, an SL resource in the unlicensed band in a selection window for an SL transmission based on the first type of sensing and the second type of sensing; and
transmitting, by the UE, the SL transmission via the SL resource using the SL RAT.

2. The method of claim 1, wherein the non-SL RAT comprises a wireless fidelity (WiFi) RAT.

3. The method of claim 1, the performing the first type of sensing comprising:
receiving, by the UE, a sidelink control information (SCI);
decoding, by the UE, the SCI; and
measuring, by the UE, a reference signal received power (RSRP) based on the SCI to determine first one or more occupied resources in the unlicensed band.

4. The method of claim 3, further comprising:
excluding, by the UE, the first one or more occupied resources from a set of resources used for candidate selection.

5. The method of claim 1, the performing the second type of sensing comprising:
detecting, by the UE, a decoding failure during the performing the first type of sensing;
performing, by the UE, a clear channel assessment (CCA) procedure; and
measuring, by the UE, a received signal strength indicator (RSSI) during the CCA procedure to identify second one or more occupied resources in the unlicensed band sensed by the second type of sensing.

6. The method of claim 5, further comprising:
excluding, by the UE, the second one or more occupied resources from a set of resources used for candidate selection based on the second type of sensing.

7. The method of claim 5, the measuring the received RSSI comprising:
measuring, by the UE, the received RSSI in at least one symbol in an SL slot or in a fraction of time of each of the at least one symbol in the SL slot.

8. The method of claim 1, wherein the selection window is no earlier than a listen before talk (LBT) duration of a LBT procedure.

9. The method of claim 1, further comprising:
determining, by the UE, possible future resources that are available to be occupied based on the first type of sensing and the second type of sensing; and
excluding, by the UE, the possible future resources from a set of resources used for candidate selection.

10. The method of claim 1, further comprising:
determining, by the UE, a channel access busy ratio (CABR) corresponding to a portion of SL sub-channels occupied by the first one or more SL transmissions only or by the second one or more transmissions only in a SL resource pool; and
performing, by the UE, SL congestion control based on the CABR.

11. The method of claim 1, further comprising:
determining, by the UE, a channel busy ratio (CBR) corresponding to a portion of SL sub-channels occupied by the first one or more SL transmissions only or by the second one or more transmissions only in a SL resource pool; and
performing, by the UE, SL congestion control based on the CBR.

12. The method of claim 1, further comprising:
collecting, by the UE, statistics of an availability of one or more resources in the unlicensed band occupied by a RAT transmission, a result of the statistics being used for selecting at least one of a preferred resource or a non-preferred resource to be used in an Inter UE Coordination (IUC) process.

13. The method of claim 12, further comprising:
collecting, by the UE, an RSRP for one or more symbols of the sensing window; and
decoding, by the UE, an SCI,
wherein the collecting the statistics of the availability of the one or more resources is performed when the UE fails to decode the SCI and an RSSI is larger than a threshold.

14. A user equipment (UE), comprising:
at least one processor; and
a non-transitory computer readable storage medium storing programming, the programming including instructions that, when executed by the at least one processor, cause the UE to perform operations including:
performing a first type of sensing in a sensing window to detect first one or more sidelink (SL) transmissions in an unlicensed band using an SL radio access technology (RAT);
performing a second type of sensing to detect second one or more transmissions in the unlicensed band using a non-SL RAT different from the SL RAT, the second type being different from the first type;
selecting an SL resource in the unlicensed band in a selection window for an SL transmission based on the first type of sensing and the second type of sensing; and
transmitting the SL transmission via the SL resource using the SL RAT.

15. The UE of claim 14, wherein the non-SL RAT comprises a wireless fidelity (WiFi) RAT.

16. The UE of claim 14, the performing the first type of sensing comprising:
receiving a sidelink control information (SCI);
decoding the SCI; and
measuring a reference signal received power (RSRP) based on the SCI to determine first one or more occupied resources in the unlicensed band.

17. The UE of claim 14, the performing the second type of sensing comprising:
detecting a decoding failure during the performing the first type of sensing;
performing a clear channel assessment (CCA) procedure; and
measuring a received signal strength indicator (RSSI) during the CCA procedure to identify second one or more occupied resources in the unlicensed band sensed by the second type of sensing.

18. A non-transitory computer-readable medium having instructions stored thereon that, when executed by a user equipment (UE), cause the UE to perform operations, the operations comprising:
performing a first type of sensing in a sensing window to detect first one or more sidelink (SL) transmissions in an unlicensed band using an SL radio access technology (RAT);
performing a second type of sensing to detect second one or more transmissions in the unlicensed band using a non-SL RAT different from the SL RAT, the second type being different from the first type;
selecting an SL resource in the unlicensed band in a selection window for an SL transmission based on the first type of sensing and the second type of sensing; and
transmitting the SL transmission via the SL resource using the SL RAT.

19. The non-transitory computer-readable medium of claim 18, wherein the non-SL RAT comprises a wireless fidelity (WiFi) RAT.

20. The non-transitory computer-readable medium of claim 18, the performing the first type of sensing comprising:
receiving a sidelink control information (SCI);
decoding the SCI; and
measuring a reference signal received power (RSRP) based on the SCI to determine first one or more occupied resources in the unlicensed band.
